(19) United States
(12) Patent Application Publication
(10) Pub. No.: US 2002/0167490 A1
(43) Pub. Date: Nov. 14, 2002

(54) Method and system for dynamically replacing a component in a communication system

(76) Inventors: Haim Weissman, Haifa (IL); Victor H. Ben-Sasson, Haifa (IL); Itsik Boger, (US)

Correspondence Address: Qualcomm Incorporated, Patents Department, 5775 Morehouse Drive, San Diego, CA, 92121-1714, US

(21) Appl. No.: 10/043,461

(22) Filed: Jan. 10, 2002

Related U.S. Application Data
(60) Provisional application No. 60/290,248, filed on May 10, 2001.

(51) Int. Cl. G09G 5/08

(52) U.S. Cl. 345/158

(57) ABSTRACT

Disclosed is a method for replacing a remote unit in a communication system. The method includes the steps of determining that a removed remote unit has been removed from the communication system. The method also includes the step of determining that a new remote unit has been installed in the place of the removed remote unit. The steps of the method further include recalling parameters associated with the removed remote unit and providing the recalled parameters associated with the removed remote unit to the new remote unit.

### RELATED APPLICATIONS

This application claims priority to U.S. Provisional Application No. 60/290,248, filed on May 10, 2001.

### BACKGROUND OF THE INVENTION

1. Field of the Invention

The present invention relates generally to wireless communications, and more particularly to a method and system for initializing the parameters of a new remote unit with saved parameters from a removed remote unit.

2. Brief Description of the Related Art

In wireless cellular communication systems, communications between users are conducted through one or more base stations. The term forward link is used to refer to communications from a base system to a subscriber station, and the term reverse link is used to refer to communications from a subscriber station to a base station. A subscriber station is a device that is used by an individual who subscribes to a communication provider for communication services. For example, a person who uses a conventional cellular telephone is a subscriber to the cellular telephone services provided by a cellular telephone service provider, such as Leap Wireless International Inc. Accordingly, the cellular telephone would be considered a subscriber station.

By transmitting information on a reverse link to a base station, a subscriber may communicate with people at different locations through any one of a number of communication systems, including conventional telephones, cellular telephones, or the Internet. The base station receives the voice or data information from a first subscriber station and routes the information to a Base Station Controller (BSC). Since the locations of both the base station and the BSC are fixed, the communication between the base station and the BSC is over a fixed communication link, such as a line-of-site microwave link or a wire line connection. The base station controller routes the information to a Mobile Switching Controller (MSC). The base station serving the subscriber stations sends the information back to the subscriber on the forward link.

As a subscriber station moves around, the quality of the forward and reverse links, and the ability of the forward and reverse links to transmit data, will vary. In particular, a user of a subscriber station may go inside of a building or enter an area where signals are blocked, such as a tunnel or valley. When the user does so, the subscriber station may not be able to receive the signals transmitted by the base station or may not be able to transmit signals to the base station.

One solution to this problem is to establish a relay station that can receive signals from a base station and relay or retransmit those signals to the user's subscriber station. However, in complex structures, such as buildings having several floors or corridors, a simple relay station is not effective. Accordingly, another approach is to place a master system unit at a location at which signals can be easily transmitted to and from a base station. Signals carrying information are then communicated over a wireline to a remote unit. The remote unit transmits the received information to subscriber stations within an area into which signals transmitted directly from the base station cannot be easily received. Likewise, the remote unit receives information from subscriber stations within the area. The remote unit then communicates the information received from the subscriber stations over wire lines to the master system unit. The master system unit communicates the information over the air to the base station.

One consideration in such a configuration of master system unit and remote units is power control. The amount of power that is transmitted to and from a base station must be controlled in order to ensure that system parameters are not violated. For example, there may be limits imposed by a governmental agency, such as the U.S. Federal Communications Commission, on the maximum amount of power that can be transmitted. This requires that the amount of gain in the link between the master system unit and the subscriber unit be controlled. In a typical system, such as a system that is installed in a building, there may be several remote units that are each coupled to a master system unit. The length of the wire line over which the master system unit communicates with each remote unit will be different for each remote unit, depending upon the location of the remote unit in the building. The signal losses due to the length of the wire line makes it necessary to add gain (i.e., amplify) to the signal at the remote unit. Furthermore, the differences in the lengths of the wire line to each remote unit make it necessary to uniquely set the gain in each remote unit. This is typically done by taking the master system unit and the remote units out of service and applying a test signal of known characteristics to the system so that the gain parameters of each remote unit may be determined. Once the system is set up, if a remote unit needs to be replaced, the setup process must be repeated for that remote unit. Therefore, the entire system must be removed from service in order to allow a test signal to be applied to the master system unit and to the remote unit. It is both expensive and burdensome to take the system out of service to replace a remote unit.

### SUMMARY OF THE INVENTION

In accordance with one aspect of the invention, provided is a method for replacing a remote unit in a communication system. The method first includes the step of installing a new remote unit in the place of a removed remote unit. The method also includes the step of recalling parameters associated with the removed remote unit, getting the gain characteristics from the new remote unit, processing the gain characteristics of the new remote unit to attain attenuation parameter and providing the processed attenuation parameters to the new remote unit.

In accordance with another aspect of the present invention, provided is a method for replacing a remote unit in a communication system. The method includes the steps of determining that a removed remote unit has been removed from the communication system and determining that a new remote unit has been installed in the place of the removed remote unit. The method also includes the step of recalling parameters associated with the removed remote unit, getting the gain characteristics from the new remote unit, processing the gain characteristics from the new remote unit to attain attenuation parameters and providing the processed attenuation parameters to the new remote unit.

In accordance with still another aspect of the present invention, provided is a system for replacing a remote unit in a communication system. The system includes a master system unit having a memory component and a new remote unit being electronically connected to the master system unit. The master system unit memory component includes stored parameters from a removed remote unit.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 is a block diagram of an in-building communication system according to the present invention;

FIG. 2 is a block diagram of a portion of the communication system according to the present invention;

FIG. 3 is a flow chart illustrating an initialization process for the communication system according to the present invention; and

FIG. 4 is a flow chart illustrating the process for providing parameters from a removed remote unit to a new remote unit according to the present invention.

### DETAILED DESCRIPTION OF THE PREFERRED EMBODIMENTS

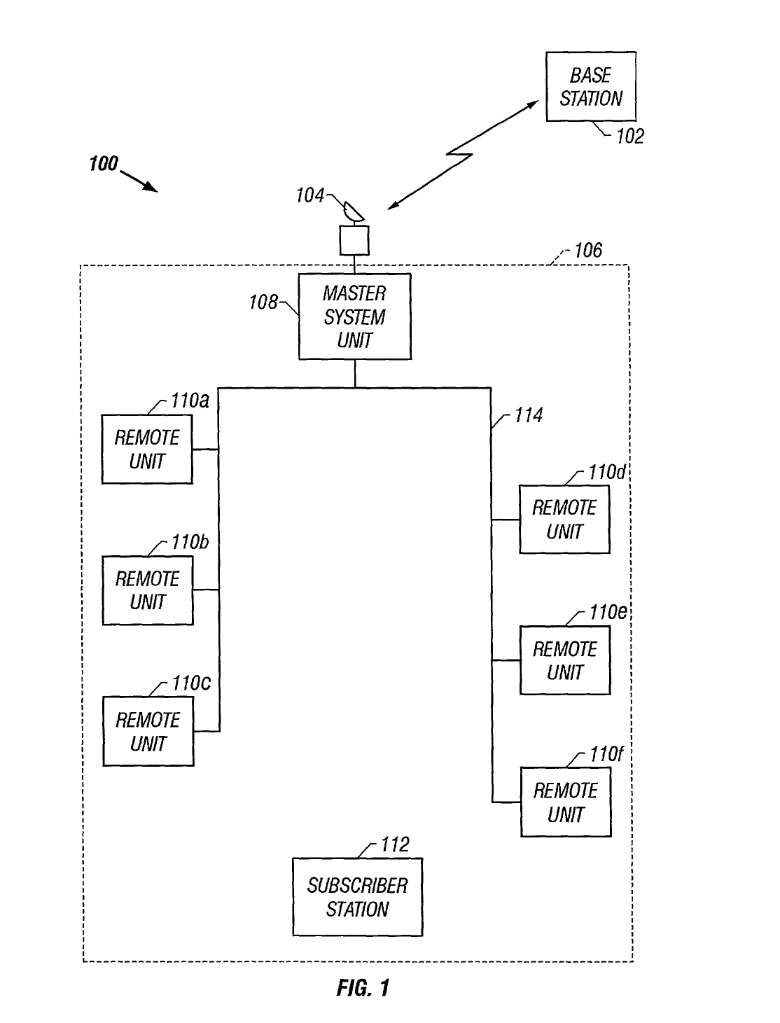

FIG. 1 illustrates an in-building repeater communication system 100, which is disclosed in pending patent application entitled: “In-building Radio Frequency Coverage,” Ser. No. ______, filed on ______, which is assigned to the assignee of the present invention and which is incorporated herein by reference in its entirety as if set forth in full herein. The communication system 100 includes a base station 102 that transmits signals to an antenna 104, which is located preferably on top of building 106. The interior of the building 106 is substantially closed off to radio-frequency (RF) electromagnetic radiation received from the base station 102. A master system unit 108, which is preferably located within building 106, receives the transmitted signals from the base station 102 via the antenna 104. Preferably, the RF signals emitted by the base station 102 are a code division multiple access (CDMA) signals, operating at an industry-standard chip rate and in an industry-standard frequency band, although the principles of the present invention are also applicable to other coding and transmission schemes.

The master system unit 108 acts as a first variable-gain repeater of signals received from the base station 102 and transfers the information and the signals received from the base station 102 to a plurality of remote units 110ₐ through 110_{f} located within the building 106. The signals radiated from remote units 110 are in a form receivable by a subscriber station 112 located within building 106. The subscriber station 112 is adapted to receive signals emitted by the base station 102. Shown are remote units 110ₐ through 110_{f} installed throughout the building 106 to provide wireless communications throughout the building 106 to one or several subscriber stations 112. The remote units 110ₐ through 110_{f} are electronically connected to the master system unit 108 by one or more wires or, most preferably, by coaxial cables 114 so that signals may be transferred between the master system unit 108 and the remote units 110.

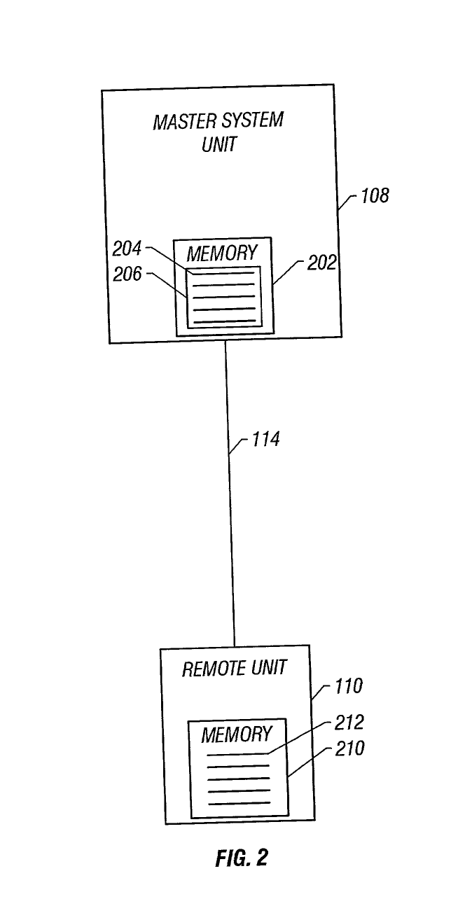

FIG. 2 illustrates the master system unit 108 electronically connected by a wire or cable 114 to a representative remote unit 110. The master system unit 108 includes a memory component 202 or other storage device. Stored within the memory component 202 is a plurality of parameters 204 for each remote unit in the communication system. The parameters associated with the remote units are compiled in a manner to comprise a remote unit table 206 stored within memory 202. The remote units 110 each include a remote unit memory 210 or other storage device. Stored within memory 210 is a plurality of parameters 212.

Each remote unit 110 in the communication system is identified by a remote unit ID code, which is unique to each remote unit in the communication system. Each remote unit further is identified by a unique remote unit identifier, such as an electronic serial number (ESN), which is unique to each remote unit that is manufactured. In the preferred embodiment, the ESN is permanently loaded or burned into the remote unit memory 210 at the time the remote unit is manufactured. The ESN allows the master system unit to uniquely identify each remote unit so that the master system unit can determine when a remote unit has been replaced in the communication system with a new remote unit. The remote unit memory 210 further includes the version of the remote unit and the gain characteristics of the remote unit. Each remote unit parameter 212 includes that remote unit's specific remote unit ID code, unique unit identifier, such as the ESN, the remote unit version, and the remote unit gain characteristics. The master system unit memory 202 also includes each of the remote unit's specific information. The master system unit differentiates each remote unit 110 in the communication system by the remote unit ID code.

During operation, if a remote unit needs to be replaced, the remote unit is removed from the communication system, and a new remote unit is installed in the location within the communication system where the removed remote unit was located. The communication system according to the present invention has a predetermined number of remote units ID codes from which the installer of the communication system and of the remote unit may select from. The remote unit installed in the communication system may have similar remote unit ID codes as other remote units installed in other communication systems. However, each remote unit ID code for each remote unit in the same communication system is unique. During installation, a switch within the remote unit may be set by the installer to determine the remote unit ID code. As by way of illustration, FIG. 1 illustrates remote units 110ₐ through 110_{f}. The unique remote unit ID code allows the master system unit 108 to associate each remote unit 110 in the communication system with the set of parameters related to the physical location of each remote unit 110 within the communication system. The physical location of each remote unit 110 is important because each remote unit 110 is connected to the master system unit 108 by a wire line connection, and the length of the wire line depends upon the physical location of each remote unit 110 within the building 106 and the distance of each remote unit 110 from the master system unit 108.

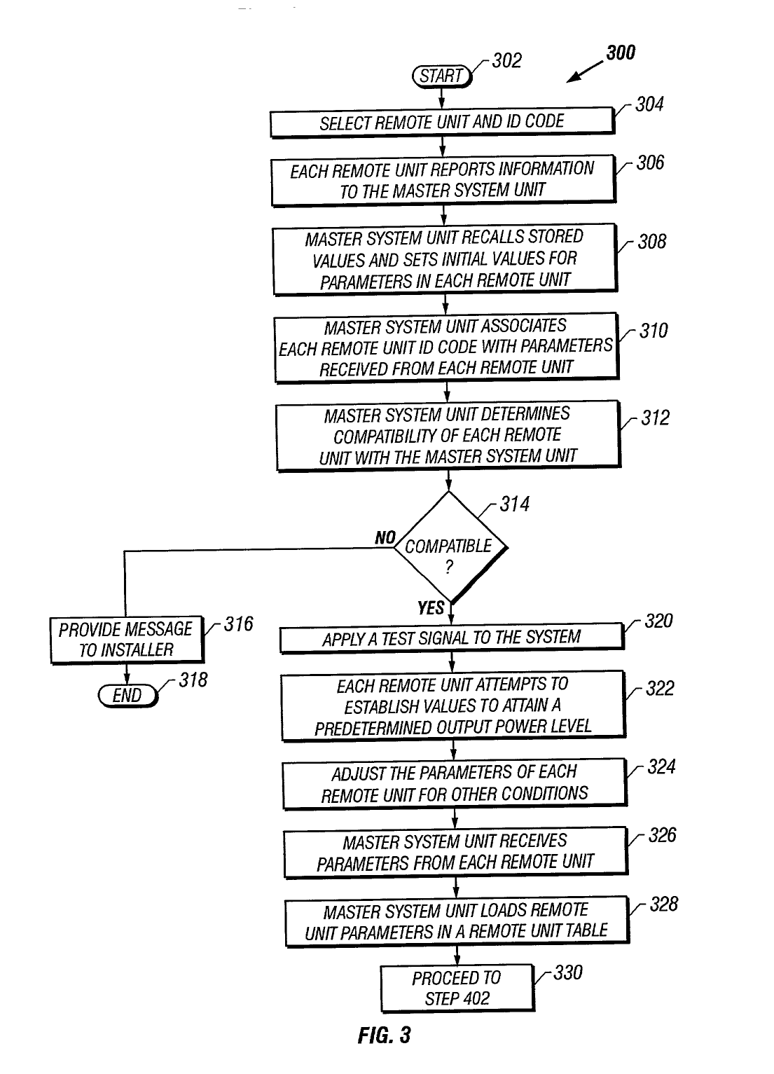

The communication system is initialized prior to being placed into service. As illustrated in FIG. 3, the initialization process 300 starts at step 302. At step 304, the installer selects a remote unit and remote unit ID code that is unique to the communication system. At step 306, each remote unit 110 in the communication system reports or transmits information from the remote unit's memory 210 to the master system unit 108. The information transmitted to the master system unit 108 includes the remote unit ID code, the ESN of the remote unit, and the version of the remote unit. As shown in step 310, the remote unit table 206 associates each remote unit ID code with the parameters reported or received by the remote unit 110 in which that remote unit ID has been set. In addition, the ESN and version of each remote unit ID are listed in the remote unit table 206.

As shown in step 312, the master system unit 108 determines the compatibility of each remote unit 110 with the master system unit 108 by reviewing the version of each remote unit 110. The master system unit 108 will not activate a remote unit 110 that is incompatible with the master system unit 108. As shown in step 314, if the remote unit 110 is not compatible with the master system unit 108, then at step 316 a message is provided to the installer stating the incompatibility of the remote unit 110 and the master system unit 108, and the process ends at step 318 for that particular remote unit 110. If the version of the remote unit 110 is compatible with the master system unit 108, then, the communication system proceeds to step 320.

During the initialization process, the remote units 110 are automatically calibrated. The automatic calibration is accomplished by providing a test signal having a predetermined power level to the communication system as shown in step 320. As shown in step 322, each remote unit then attempts to establish the values of the parameters for that remote unit in order to attain a predetermined output power level. As shown in step 324, once the parameters of each remote unit are set, the installer may adjust the parameters of each remote unit 110 in order to adjust for conditions that were not taken into account by the automatic calibration process. As shown in step 326, when the parameters have been correctly set, each remote unit 110 transmits the parameters associated with each remote unit to the master system unit 108. The master system unit 108 receives the parameters and stores the parameters in the remote unit table 206 as shown in step 328

The master system unit 108 recalls any stored remote unit parameters from memory 202 and sets the initial values for the parameters in each remote unit 110.

In the preferred embodiment, the parameters include the amount of attenuation that is to be set in each path of the remote unit 110 (i.e., the forward and reverse links). Preferably there are two variable remotely controllable attenuators in the forward link and two variable remotely controllable attenuators in the reverse link. The parameters include the amount of attenuation to be applied by each of the forward and reverse link attenuators.

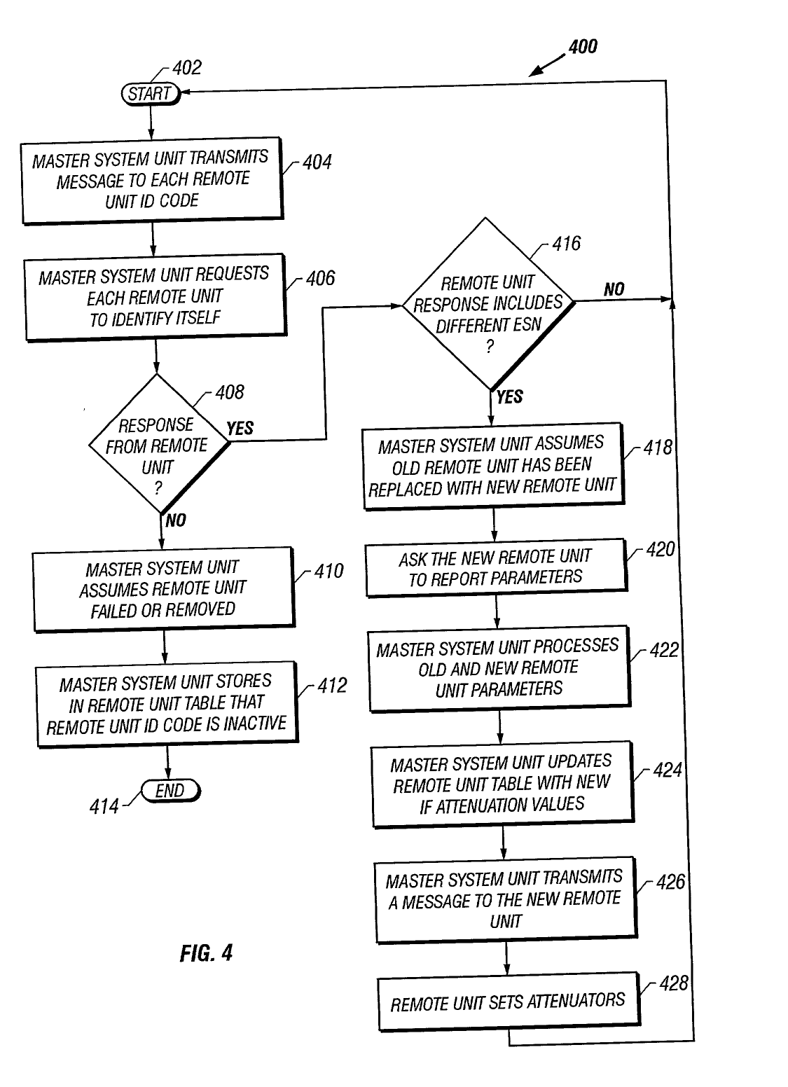

After the remote unit table 206 is generated and loaded in the master system unit 108, then the communication system becomes operational. Upon becoming operational and as illustrated in FIG. 4, the communication system undertakes a systematic and regular polling process starting at step 402 to determine if a remote unit has been removed or has failed. As shown in step 404, the polling process includes the master system unit 108 transmitting periodic messages directed to each remote unit ID code to determine the status of each remote unit 110. The transmitted message from the message system unit 108 requests that the remote unit 110 associated with the requested remote unit ID code to identify itself to the master system unit 108 by transmitting its ESN as shown in step 406. As shown in step 408, the master system unit 108 determines whether a response has been received from the remote unit ID code. As shown in step 410, if there is no response to the message sent from the master system unit 108, then the master system unit 108 assumes that either the remote unit 110 assigned to the remote unit ID code associated with that message has failed or that the remote unit 110 assigned to that remote unit ID code has been removed from the communication system. As shown in step 412, a master system unit 108 stores in the remote unit table 206 that the remote unit 110 associated with the requested remote unit ID code is inactive. This portion of the process then ends at step 414.

In the alternative, as shown in step 416, if the remote unit 110 responds to the master system unit 108 request, the master system unit 108 determines whether the response from the remote unit 110 includes a different ESN than as associated in the remote table 206 with the requested remote unit ID cable. If the ESN is not different, the polling process is complete until the next poll of the system. If the remote unit 110 responds to the master system unit 108 request, but with a different ESN than is associated in the remote table 206 with the requested remote unit ID code, then as shown in step 418 the master system unit 108 assumes that the previous remote unit 110 associated with the requested remote unit ID code has been replaced by a new remote unit 110 that is now assigned to the requested remote unit ID code. In response to this assumption, as shown in step 420, the master system unit 108 requests the new remote unit to report its gain characteristics. The new remote unit 110 reports the gain characteristics stored in memory 212 to master system unit 108. The master system unit compares the new remote unit gain characteristics with the old remote unit gain characteristics and attenuation parameters to obtain the new remote unit attenuation parameters. As shown in step 422, the master system unit 108 transmits a message or provides the new remote unit attenuation parameters and the requested remote ID code to the new remote unit 110. The transmitted message from the master system unit 108 to the new remote unit 110 also includes parameters such as forward and reverse link cable insertion loss, that were associated with the removed remote unit. As stated above, the parameters for the removed remote unit include the values associated with the requested remote unit ID code that are stored in the remote unit table 206.

The new attenuation parameters include the amount of attenuation set in each variable remotely controllable attenuator. In addition, the gain characteristics associated with the new remote unit are stored in master system unit 108 at memory 206 in step 424.

The gain characteristics are the amount of gain in the forward link of the remote unit with all forward link attenuators set to zero attenuation, referred to as forward-gain-zero. The gain characteristics also include the amount of gain in the reverse link of the remote unit with all reverse link attenuators set to zero attenuation, referred to as reverse-gain-zero. The forward-gain-zero and reverse-gain-zero values of each remote unit 110 will differ. Such differences are taken into account, by the master system unit, during the processing done at step 422. The preferred method of taking into account the differences from the removed remote unit forward-gain-zero from the new remote unit forward-gain-zero is to subtract the old forward-gain-zero from the removed remote unit attenuation values for the forward link IF attenuator to determine the difference between the removed remote unit attenuation values for the forward link IF attenuator and the removed remote unit forward-gain-zero. The new remote unit forward-gain-zero value is attained from the memory of the new remote unit and is then added to that difference. The resulting value is a new IF attenuation value for the IF forward link attenuator.

Similarly, the removed remote unit reverse-gain-zero-reverse-gain-zero is subtracted from the IF attenuation value of the removed remote unit reverse link attenuator and the new reverse-gain-zero is attained from the memory of the new remote unit and is added to that difference. As shown in step 424, the master system unit 108 then updates the remote unit table 206 by storing the new IF attenuation values to the remote table unit 206. The polling process then ends until the next polling cycle is started at step 402. As shown in step 426, the master system unit 108 sends the processed attenuation parameters together with the recalled insertion loss parameters to the new remote unit 100. As shown in step 428, the new remote unit 110, receives the processed attenuation parameters from the master system unit 108 and sets its attenuators to the reported values.

Although this invention has been shown and described with respect to detailed embodiments, those skilled in the art will understand that various changes in form and detail may be made without departing from the scope of the claimed invention.

What is claimed is:

1. A method for replacing a remote unit in a communication system, comprising:
installing a new remote unit in the place of a removed remote unit;
receiving gain characteristics associated with the new remote unit; receiving gain characteristics and attenuation parameters associated with the removed remote unit;
calculating attenuation values for the new remote unit based upon the new remote unit gain characteristics and the removed remote gain characteristics and attenuation parameters; and
providing the calculated attenuation parameters to the new remote unit.

2. The method of claim 1, further comprising the step of determining that the new remote unit has been installed in the place of the removed remote unit.

3. The method of claim 2, wherein the step of determining that a removed remote unit has been replaced with a new remote unit in the communication system includes:
sending a message to a location in the communication system where the remote unit was installed; and
receiving a message from the new remote unit in response to the message sent to the location in the communication system where the removed remote unit was installed.

4. The method of claim 3, wherein the message sent is directed to a remote unit ID code.

5. The method of claim 3, wherein the message sent requests a unique remote unit identifier.

6. The method of claim 5, further comprising:
the new remote unit sending a message in response to the request for the unique remote unit identifier.

7. The method of claim 6, wherein the determination that the removed remote unit has been replaced with the new remote unit is made by comparing the unique remote unit identifier within the message received from the new remote unit with the unique remote unit identifier associated with the removed remote unit.

8. The method of claim 1, further comprising:
adjusting the attenuation for the new remote unit based upon the gain characteristics of the new remote unit, the gain characteristics of the removed remote unit and the calculated attenuation parameters of the removed remote unit.

9. The method of claim 8, further comprising:
sending the processed IF attenuation parameters to the new remote unit; and the new remote unit setting its IF attenuators to the reported values.

10. The method of claim 1, wherein the recalled parameters are recalled from a master system unit.

11. The method of claim 10, wherein the master system unit further comprises memory with stored parameters from the removed remote unit, the stored parameters including:
gain characteristics and attenuation parameters from the removed remote unit;
a unique remote unit identifier assigned to the removed remote unit; and
a remote unit ID code assigned to the removed remote unit.

12. The method of claim 8, further comprising:
determining new IF attenuation values for an IF forward link attenuator;
determining new IF attenuation values for an IF reverse link attenuator; and
sending the IF attenuation values to the new remote unit.

13. The method of claim 12, further comprising:
setting at least one attenuator in the new remote unit based upon the determined IF attenuation values.

14. The method of claim 12, wherein the determination of the new IF attenuation value for the IF forward link attenuator further comprises:
recalling an attenuation value for the forward link IF attenuator of the removed remote unit;
receiving the forward-gain-zero value for the removed remote unit;
subtracting the forward-gain-zero value for the removed remote unit from the attenuation value for the forward link IF attenuator of the removed remote unit to determine a forward link differential value;
recalling a forward-gain-zero value for the new remote unit; and
adding the forward-gain-zero value for the new remote unit to the forward link differential value.

15. The method of claim 14, wherein the determination of the new IF attenuation value for the IF reverse link attenuator further comprises:
recalling an attenuation value for the reverse link IF attenuator of the removed remote unit;
receiving the reverse-gain-zero value for the removed remote unit;
subtracting the reverse-gain-zero value for the removed remote unit from the attenuation value for the reverse link IF attenuator of the removed remote unit to determine a reverse link differential value;
recalling a reverse-gain-zero value for the new remote unit; and
adding the reverse-gain-zero value for the new remote unit to the reverse link differential value.

16. The method of claim 12, further comprising:
storing the new IF attenuation values in a master system unit memory.

17. The method of claim 16, further comprising:
the master system unit storing the new IF attenuation values in a remote unit table.

18. The method of claim 8, wherein the gain characteristics of the removed remote unit are recalled from a remote unit table.

19. The method of claim 18, wherein the remote unit table is located within a master system unit.

20. A method for replacing a remote unit in a communication system, comprising:
determining that a removed remote unit has been removed;
determining that a new remote unit has been installed in the place of the removed remote unit;
recalling gain characteristics associated with the removed remote unit;
receiving gain characteristics from the new remote unit;
calculating IF attenuation parameters for the new remote unit; and
providing the calculated parameters to the new remote unit.

21. The method of claim 20, wherein the step of determining that a removed remote unit has been replaced with a new remote unit in the communication system includes:
sending a message to a remote unit ID code in the communication system where the remote unit was installed; and
receiving a message from the new remote unit in response to the message sent to the remote unit ID code in the communication system where the removed remote unit was installed.

22. The method of claim 21, wherein the message sent requests a unique remote unit identifier.

23. The method of claim 22, further comprising:
the new remote unit sending a message in response to the request for the unique remote unit identifier;
comparing the unique remote unit identifier within the message received from the new remote unit with the unique remote unit identifier associated with the removed remote unit; and
determining that the removed remote unit has been replaced with the new remote unit.

24. The method of claim 20, further comprising:
recalling gain characteristics attenuation parameters of the removed remote unit;
receiving gain characteristics of the new remote unit;
determining attenuation parameters of the new remote unit based upon the gain characteristics and attenuation parameters of the removed remote unit and the gain characteristics of the new remote unit; and
sending the attenuation parameters to the new remote unit

25. The method of claim 20, wherein the recalled parameters are recalled from a master system unit.

26. The method of claim 24, further comprising: determining new IF attenuation values for an IF forward link attenuator;
determining new IF attenuation values for an IF reverse link attenuator; and adjusting the parameters for the new remote unit based upon the determined IF attenuation values.

27. The method of claim 26, further comprising:
setting at least one attenuator in the new remote unit based upon the determined IF attenuation values.

28. The method of claim 26, wherein the determination of the new IF attenuation value for the IF forward link attenuator further comprises:
recalling an attenuation value for the forward link IF attenuator of the removed remote unit;
recalling a forward-gain-zero value for the removed remote unit;
subtracting the forward-gain-zero value for the removed remote unit from the attenuation value for the forward link IF attenuator of the removed remote unit to determine a forward link differential value;
receiving the forward-gain-zero value for the new remote unit; and
adding the forward-gain-zero value for the new remote unit to the forward link differential value.

29. The method of claim 12, wherein the determination of the new IF attenuation value for the IF reverse link attenuator further comprises:
recalling an attenuation value for the reverse link IF attenuator of the removed remote unit;
recalling a reverse-gain-zero value for the removed remote unit;
subtracting the reverse-gain-zero value for the removed remote unit from the attenuation value for the reverse link IF attenuator of the removed remote unit to determine a reverse link differential value;
receiving the reverse-gain-zero value for the new remote unit; and
adding the reverse-gain-zero value for the new remote unit to the reverse link differential value.

30. The method of claim 26, further comprising:
the master system unit storing the new IF attenuation values.

31. The method of claim 30, further comprising:
the master system unit storing the new IF attenuation values in a remote unit table.

32. The method of claim 24, wherein the gain characteristics of the removed remote unit are recalled from a remote unit table located within a master system unit.

33. A system for replacing a remote unit in a communication system, comprising:
a master system unit having a memory component;
a new remote unit being electronically connected to the master system unit; and
the master system unit memory component including stored parameters from a removed remote unit.

34. The system of claim 33, further comprising:
the new remote unit having a memory component; and
the new remote unit memory component including stored parameters from the removed remote unit.

35. The system of claim 34, wherein the master system unit and the new remote unit are electronically connected by a wire.

36. The system of claim 33, wherein the master system unit stored parameters further includes:
gain characteristics from the removed remote unit;
a unique remote unit identifier assigned to the removed remote unit; and
a remote unit ID code assigned to the removed remote unit.

37. The system of claim 33, wherein the master system unit stored parameters further includes:
IF attenuation values for an IF forward link attenuator;
IF attenuation values for an IF reverse link attenuator;
forward insertion loss value of the IF cable connecting the master system unit and the remote unit; and
reverse insertion loss value of the IF cable connecting the master system unit and the remote unit.

38. The system of claim 37, wherein the stored parameters for the master system unit are located in a remote unit table.
